(19) United States
(12) Patent Application Publication
(10) Pub. No.: US 2007/0166129 A1
(43) Pub. Date: Jul. 19, 2007

(54) Adjustable fastening surface device with releasable thread form

(76) Inventor: David Gordon Janeway, New Westminster (CA)

Correspondence Address: DAVID GORDON JANEWAY, SUITE 303, 225 ROYAL AVENUE, NEW WESTMINSTER, BC, V3L 1H5, CA

(21) Appl. No.: 11/646,640

(22) Filed: Dec. 27, 2006

Related U.S. Application Data
(63) Continuation-in-part of application No. 10/258,949, filed on Mar. 7, 2003, now abandoned.

(51) Int. Cl. F16B 35/00

(52) U.S. Cl. 411/914; 411/908; 411/395

(57) ABSTRACT

This invention relates to an adjustable fastening surface device with an integral releasable thread form. This device allows the adjustable anchoring of materials to hardened concrete or similar cold castable material with relatively low tensile and shear strength properties when contrasted with the compressive strength properties. The fastening device is cast or inserted into concrete or similar material prior to setting or curing, or can be inserted into cold castable material contained within a suitable void in any hard or impenetrable substrate. After the castable material has hardened, the fastening device can easily be rotated outwards from the initial cast or inserted position by means of a releasable thread form

### REFERENCES CITED

EP 0 693 597 A1, Cretti, Piero
U.S. Pat. No. 5,895,186 Cretti, Piero
U.S. Pat. No. 5,895,186 Gianuzzi, et al
U.S. Pat. No. 4,642,964 Kellison, Roger
U.S. Pat. No. 5,490,365 Roth, Steven

### RELATED APPLICATION

This application is a continuation-in- part of an application Ser. No. 10/258,949 entitled “Adjustable Fastening Surface Device embedded in cast panel or other product”

### STATUS OF PRIOR ART

Concrete is difficult to attach materials to. Regular weight concrete by nature is hard, brittle and abrasive. In the past small blocks of wood referred to as “nogs” were cast flush into the surface of concrete at locations where fastening was desired. The term “nog” refers to a wooden peg or pin or block laid in amongst regular clay bricks in unit masonry construction to provide a pierceable anchoring target for nails and screws to be driven and anchored into. This definition is available on the internet at http:H/dictionary.reference.com/browse/nog

This practice was adopted for poured concrete construction. The advantage of block type nogs over peg type nogs was that block type nogs have a relatively large target area for these fasteners to land into, thus reducing the required precision of the location and alignment of fastening. The drawback of nogs is that they became loose over time as they dried and shrank in the mortar pocket or concrete that surrounded them. This shrinkage affected the pullout anchoring capacity by reducing the peripheral friction. For this reason nogs were only used where lateral anchoring rather than pullout anchoring was required. This low pullout resistance meant that shimming was required between the nog and the object being attached. Shims were required if a gap existed due to variations in the adjacent masonry or concrete. These shims prevented the pulling of the nog out from its recess as screws were tightened or nails set. Shims also increased the lateral stability of the joint.

Some of the disadvantages of these wooden nogs can be overcome with the use of plastics that do not shrink, rot or are attacked by insects. A type of plastic nog is shown and discussed in Cretti EP 0 693 597 A1. Here the “nog” (FIG. 1) provides a harder more robust fastening surface than a surrounding soft foamed plastic panel.

This use of the word “nog” in this context is somewhat confusing as the function of Cretti's “insert” is to provide a robust fastening point in an otherwise non robust foamed plastic panel, really the opposite function of a nog. Confounding this confusion is that Cretti's “insert” is not cast into concrete or unit masonry but rather inserted into a foam plastic panel by screwing mean into a hole in the panel. The only contact with concrete is made when the “insert” is held in position against concrete poured within the assembly by a threaded tie rod which projects out of the poured concrete mass.

Protruding threaded rods have been cast into concrete for hundreds of years and iron rods have been anchored into masonry since antiquity. The advantage is that they can reliably withstand the tension of pullout forces. The disadvantage is that, by nature, any threaded stud must pass through or into a hole or slot in the object being fastened to. This requires careful alignment or adjustability in the object being attached or fabrication of the attachment on the jobsite, or alignment made prior to the setting of the concrete. In short, the fastening target of a threaded rod or stud is small relative to the tolerances required. Embedded rods and studs on formed concrete surfaces require modifications to the concrete forms and can render the assembly and removal of concrete forms difficult or impossible because they are obstructed by these projections.

Bolted assemblies in concrete structures require corrosion protection or are made with expensive non-oxidating metals. Projecting metal elements can also convey moisture into the main portion of the structural reinforcement (a.k.a. creep), and they pose a projecting safety hazard to construction workers. For these reasons rods and studs are generally used only for heavy engineered anchorages where failure could result in loss of life or property.

The invention of the electric drill and suitable drill bits allowed holes to be easily drilled in hardened concrete. Anchors could be inserted in these holes and mechanically expanded by the insertion of bolts or screws. Some bolts were designed specifically that combined these functions and these became widely available. The pullout strength of this sort of system is determined by the friction induced by the jamming of the anchor against the sides of the hole. The substantial advantage to this system was that holes could be drilled where required after the concrete had set or hardened without precise prior planning and no modification to the concrete forming procedure. This practice is now commonplace primarily because the fastening target is the entire cast concrete surface. The disadvantage of using this method is the need for skilled and costly labor to measure the location of, and drill the holes.

Explosive fasteners have been used as well. They are really a variation on a hardened steel concrete nail that is driven by an explosive hammer rather than a conventional one. They are somewhat effective in light anchoring situations where failure would not result in loss of life. This restriction in use is due to the high variability of pullout strength encountered with this sort of fastener. This system is impractical for attaching aesthetically pleasing fragile cladding such as drywall, due to both the damage produced by the high energy driving of this sort of piercing fastener through the cladding, as well as the cost

Glues and adhesives are used in some parts of the world to adhere cladding materials directly to the vertical surface of concrete. The drawbacks are that the fastening surfaces must be flat, plumb, planar, dry, and that the adhesives are suitable for the temperature and humidity encountered on widely divergent building construction sites.

Steel welding panels and brackets are sometimes cast into concrete. This sort of heavy engineered structural assembly point is outside the field of this invention as it pertains to the erection of a building rather than the cladding of a building.

The advent of epoxies and other resins brings us to the realm of fasteners embedded in drilled holes filled with a masonry bonding agents such as epoxy. Epoxies and similar materials bond well to clean concrete and produce consistent pullout strengths that engineers can verify, design with and rely upon. Pullout strengths are generally higher than frictional anchors. A number of patents explored options around the idea of embedding a threaded stud or bolt for heavy anchorages of such items as securing rail restraints to concrete railroad ties as in Kellison U.S. Pat. No. 4,642,964.

In terms of the adjustment or removal of threaded fasteners, Kellison taught that a special reverse threaded stud embedded in a masonry bonding agent such as epoxy with an oppositely threaded cap nut could be removed and replaced providing that the threaded portion that was in contact with the masonry bonding agent was dipped into a release agent (Pg1 @ 67,68). This release agent is described in applications as requiring an electrical insulating value being either a plastic-based or vinyl-based dip to which Teflon may be added to serve as the release agent as well as the insulation means (Pg2 @ 44, 45, 46, and 47).

In the description of the embodiments Kellison teaches a release agent that coats the threads “may include any of a wide range of commercially available waxes or greases. Preferably the release agent includes Teflon dispersed throughout any suitably grease or grease-like lubricant that is of suitable consistency to coat the cut threads. In use in the field the first end of the shaft is dipped into the release agent to coat the threads and then the first end is inserted into the masonry bonding agent, a peroxide resin grout.

Roth U.S. Pat. No. 5,490,365 teaches that a bolt like element with threads covered in a release which may be Teflon tape (pg 3 @ 28, 29) or wax or plastic coating applied to the thread could be cast into an epoxy masonry bonding agent like epoxy. Upon hardening the epoxy forms a nut (pg 3 @ 66 and pg 4 @1,2) and that the threaded shaft can be screwed into and out of the epoxy surrounding the shaft (pg 4 @ 4) by virtue of having the bond of the bolt and epoxy broken by the release agent.

Gianuzzi U.S. Pat. No. 5,895,186 discussed that the bolt like element in Roth and Kellison failed to take into account imperfections in the threads of commercially available bolts (Pg 2 @ 38 to 62) and that the Teflon tape claimed by Roth conforms to these irregularities. This causes the bolt to bind in the cast thread of the epoxy (Pg 3 @ 4 to 8) and that it is difficult to tighten the fastening even when the release agent coating the shank is a lubricant. The drawbacks of wax, plastic and grease dips are discussed from the standpoint of the difficulty in maintaining a uniform thickness of the flank surface of the thread.

Gianuzzi teaches that this binding of a mass produced commercially available bolt can be overcome by wet applying a coating that when dry covers the bolt at a thickness of preferably 5 mils on the flank of the thread, but greater at the base of the helical groove running between the convolutions of the helical shank thread (Pg 7 @ 66, 67 and Pg 8 @ 1, 2). Gianuzzi teaches that this fully compliant coating would have a relatively high degree of sliding friction (Pg 8 @ 38 to 45) but this friction could be overcome by a lubricant.

The coating Gianuzzi prefers and claims in claim 5 and 6 is a water based polyvinyl acetal resin but teaches that this coating could be oil based as well (Pg 8 @ 28, 29, 30).

To summarize the previous art on embedded threaded fasteners: the discussion teaches two things: That when a male cast thread is covered with a suitable release agent, that a two part epoxy or peroxide—cured resinous material can, with a suitable release agent, be used as a female cast thread functioning as a nut. (Kellison, Roth, Gianuzzi) Further that the release could be a coating applied wet (Kellison vinyl or plastic dip, grease or wax dip, Roth a wax or plastic coating, Gianuzzi a water based coating that dries rapidly). That all of the above coatings by their nature coat all surfaces of a threaded when applied and can be described as “compliant”. That friction in the release agent would be an issue that could be overcome with lubricants (Kellison adding Teflon to the vinyl dip, Gianuzzi adding microcapsules to the coating). That Teflon tape could be applied dry to the threads (Roth) but that if done on a commercially available bolt the threads could bind according to Gianuzzi due to defects in manufacturing.

The prior art does not consider casting an adjustable releasable threaded fastener directly into concrete, and this is where the present invention is novel and useful. The only mention of concrete as a threading media is in Gianuzzi where he discusses the difficulty of threading concrete with a tap (Pg 1 @ 29 to 35). The casting of a thread directly into concrete would not be accomplished by Gianuzzi's preferred embodiment, a water based coating which would simply dissolve in the highly caustic, water saturated, environment of plastic concrete.

A mass produced bolt as discussed by Gianuzzi or Roth would not be suitable for use in concrete due to the close spacing of the threads and the shape and design of the thread pattern itself. The modern standard commercial thread shapes that Gianuzzi coats as shown in FIG. 8 and Roth wraps in Teflon tape were developed and standardized to fasten metals together, particularly steel

It is well known that steel has a high compressive, tensile and shear strength. Concrete in contrast has a much lower compressive strength, and is relatively weak in tension and shear. The development of reinforced concrete construction bears testament to this essential shortcoming of concrete, where steel bears the tensile loads.

A thread specifically designed for embedment in concrete that allows the concrete to act as the female portion of the thread is not shown in the prior art, neither is a suitable means for preventing said thread to slide despite the abrasive nature of concrete.

The greases and oils mentioned in the prior art may effect the concrete properties mentioned as discussed by the National Precast Concrete Association. An article published by this American association can be found on the internet at http://www.precast.org/publications/mc/TechArticles/03_Winter_Form_Release_Agents. htm# and a portion relating is reprinted as follows:

Petroleum-based reactive release agents. The majority of reactive release agents in use today have petroleum-based carrying agents. Since only a small percentage of the right fatty acid is needed to get the job done, the majority of the release agent will be the petroleum-based carrying agent. An excessive amount of fatty acid in the release agent can actually result in the fatty acid migrating into the concrete, acting as a retarder and causing soft crumbly surfaces. However, high concentrations of fatty acids can be used for conditioning and/or seasoning of forms (see seasoning).

### SUMMARY OF THE INVENTION

The innovation in all embodiments is a device that when cast or inserted in concrete or similar cold castable material imparts a partially conforming female thread in the hardened casting material. This imparted or formed thread allows the easy rotational outward adjustment, removal, or re-insertion of a number of possible threaded integral fastening and/or anchoring surfaces. These fastening and/or anchor surfaces when adjusted eliminate the need for external shims to regulate the size of a gap between the adjoining surfaces of an object being attached and the concrete or concrete composite assembly that it is being attached over. This adjustable gap creates utility in a number of ways: by overcoming variations in the planar flatness of the cast concrete or concrete composite assemblies, the creation of a desirable capillary moisture break between the concrete or concrete composite assembly and the adjoining object or cladding material, and finally by providing adjustment to correct errors in construction tolerances or settlement due to concrete shrinkage or settlement.

The adjusted device maintains a robust reliable anchoring directly into the concrete or castable substrate through a wide range of adjustment. This allows the use of the device where anchorage is required under axial tensile, lateral shear, or axial compressive loading. The pullout strength achieved for tension loading is a function of the area of thread contact which would be mirrored by the push-in strength required for compressive loading. Compressive load bearing and lateral bending strength could also be readily increased by packing a non-compressive grout under the fastening flange in a process similar to the pre-leveling adjustment and grouting of structural steel base plates.

The ease of adjustment allows long lengths of threaded shafts to be used and still be adjustable. This allows for very heavy anchoring that could exceed the yield strength of the threaded rod.

In Use

In the preferred embodiment this device provides an integral pierceable fastening flange that allows piercing fasteners to pass through and be frictionally embedded in this flange by partially projecting into a low density washer or other means of producing a suitable void in the concrete.

This device can be cast or inserted flush at the surface of concrete or other similar cold castable material at any location in any pattern through a number of affixing means.

After the cladding covers this device, a threaded bolt or rod can pass through the cladding and into a concentric hole within the device and self tap into. This provides an additional non-oxidizing, reliable anchor that can reliably bear engineered loads such as mechanical piping hung from hooks or eyes.

NOTE: The wire thread shown on Janeway's previous application U.S. Ser. No. 10/258,949 is described with a shrink-wrapped cover in the description of FIG. 5 and few lines further on as a coating. The specific nature and properties of this cover was not disclosed within the previous application.

The shrink-wrapped cover is commercially available tubing called “Heat Shrink Tubing, Thin Wall Cross Linked Polyolefin” by the NTE Electronics Company of Bloomfield, N.J. This tubing reduces in diameter by up to 50% when heated and produces both the desired shape as well as a friction reduced internal surface.

This tubing or similar sheet plastic film stretched over the male shape of the shaft threads 22 produces a semi-compliant covering known as a releasable thread form 26. This form 26 fits snugly at the thread crown 24 but hangs in an arc above the surface of the threads 22 as shown in FIG. 1c. The releasable thread form 26 is a semi-compliant plastic film or shrink wrap tubing and is used to break the bond between the fresh concrete and the threads 22 of the fastening device 10. The imperfections on the flank of the thread that Gianuzzi seeks to overcome by coating with a dipped compliant coating are no longer in contact with the cast female nut formed by the cold cast material.

The utility this creates is a low contact area between the body of the fastener and the concrete that form the nut This low contact area requires no lubrication to prevent bonding and adjustment in some cases can be done with an unaided hand, depending on the size and shape of the device as used.

This male wave shaped thread impresses a series of shallow arches in the hardened cast shape of the cast female thread. These arches are better suited to the low shear strength of concrete and resist pull out better than a standard thread, particularly a thread covered with grease or Teflon tape.

This enhanced pullout resistance is due to the interlocking shapes of male wave shape and the female arch shape. The distance between peaks relative to the depth of the arc is much longer and shallower than a standard machine thread. There is less shear tendency between the pointed thread crowns described in all the previous art including the insert shown by Cretti. The prototypes tested were easily adjusted by twisting by hand because the thread contacts only the slick inside of the tubing at the crown of the thread.

The objective of electrical insulation as in Kellison is accomplished while the low friction adjustment is improved. The shrink wrap tubing has a high insulating value as this is its function in electrical applications.

The advantage over dipped or wet applied release coating are that the fastener is shipped to the job site pre-coated and is not affected by temperature, contamination, moisture.

The preferred embodiment as shown is an adjustable nog, but other shapes of attaching surfaces could be employed as well as other metal or non metal materials used to achieve specific utility.

### The Preferred Embodiment

The fastening device 10 (FIGS. 1a and 1b) consists of a round flange 14 which allows axial rotation within it's own cast peripheral imprint without peripheral binding when inserted flush into the surface of concrete and the concrete has set. (FIG. 3)

This flange 14 is sufficient thickness to both be pierced by and to provide sufficient anchorage for piercing fasteners such as drywall screws 36 (FIGS. 4 & 5), and is made of a suitable material like cast polypropylene plastic to allow a piercing fastener to pass through and into a foamed plastic washer 20.

The shaft 12 (FIG. 1b) has a coarse threaded portion 22, preferably 4 threads per inch of a half round ¼ inch diameter female wire thread, as well as a remaining Un-threaded portion. This thread shape is preferable as the half circle shape produces a proportionately low thread surface area as opposed to the height of the thread. The crown is slightly flattened so that it will not pierce the shrink wrap tubing mentioned below when the device is restated. The function of the unthreaded portion of the shaft 12 is to provide a suitable surface for the frictional retention of the flange washer 20.

All portions of the shaft 12 at the time of manufacturing are covered with a thin wall shrink wrap tubing, this being made of a suitable polyolefin film such as that manufactured by NTE Electronics Inc of Bloomfield N.J. or other suitable plastic film that will shrink under heat or when applied in tension to produce the desired effect of forming an arch (FIG. 1c) between the thread crowns 24 to provide a gap between the arch of the plastic film or shrink wrap tubing and the valley of the thread 22.

In use the device is inserted into the surface of fresh concrete (FIG. 2) or held against a horizontal or vertical concrete form (FIG. 3) with a mounting bolt 32 and then concrete is poured around the fastening device 10.

After the concrete is set, a suitable a pin wrench (not shown) can be inserted into the adjustment holes 16 (FIGS. 1a and 1b) and the fastening device can be easily rotationally adjusted out from the cast position to allow an optional gap (FIG. 4) between the cast concrete surface and the inside of the cladding material such as drywall panel 34.

This gap allows for corrections for the concrete being cast out of plumb, out of planar flatness, or bulging or fining produced by typical wooden concrete forms.

After the drywall 34 is secured (FIG. 4 or FIG. 5) with drywall screws 36, nails, staples, etc., a threaded rod 38 can be inserted through the drywall 34 and self tap into the shaft bore 18 to provide a heavy anchoring for the threaded rod 38 and items to be anchored such as a pipe supported by a hanger loop 40.

### BRIEF DESCRIPTION OF THE DRAWINGS

FIG. 1a—is an end view of the fastening device showing the flange, shaft, bore, and adjusting holes.

FIG. 1b—A side view of the fastening device with dotted lines indicating the location of the flange washer, and its shaft, threads, bore, and the releasable thread form.

FIG. 1c—A detailed drawing showing the male thread shape, the shape of the cast female thread, and the gap between the shrink wrap tubing and the valley of the semi circular thread shape.

FIG. 2—A drawing showing the insertion of the fastening device into a fresh unset concrete surface and the initial cast position when the concrete sets and hardens

FIG. 3—A drawing showing the retention of the device against the casting surface of a concrete form by means of a mounting bolt.

FIG. 4—A drawing showing a number of the fastening devices cast into concrete where the attached drywall panel is angled to provide an irregular gap thereby demonstrating the adjustability and adaptability of said devices.

FIG. 5—A drawing showing a device cast into the underside of a concrete slab, with drywall or other cladding attached to the fastening flange with screws, and a threaded rod inserted into the concentric bore of the device for heavy anchoring.

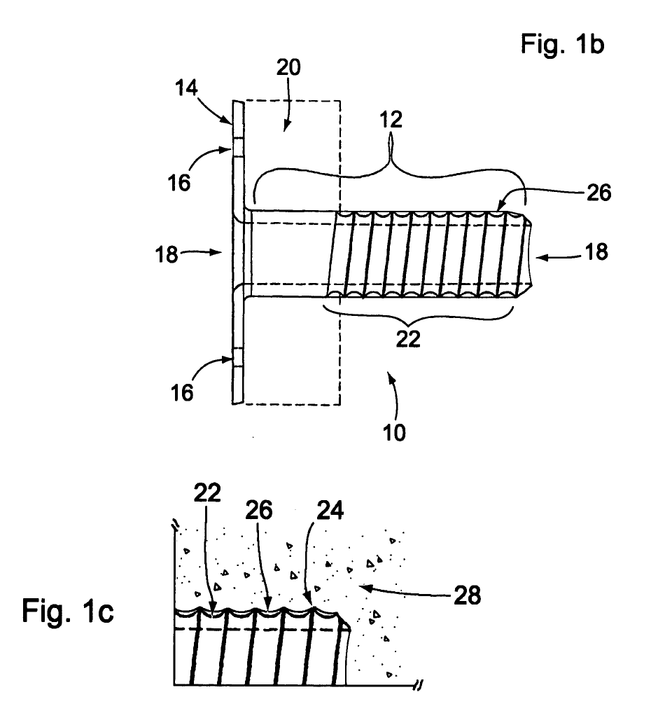

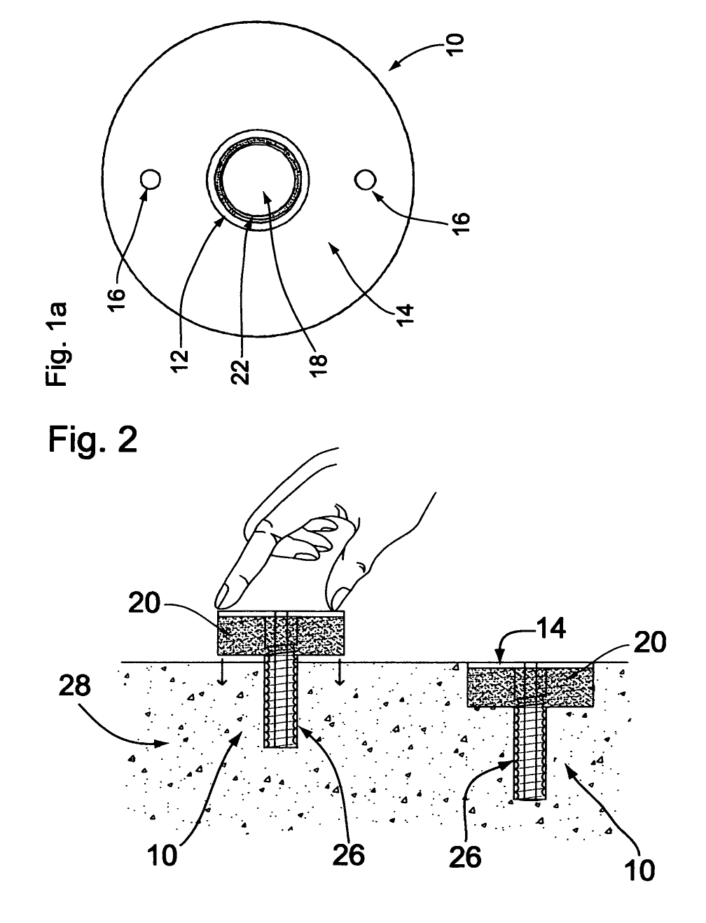

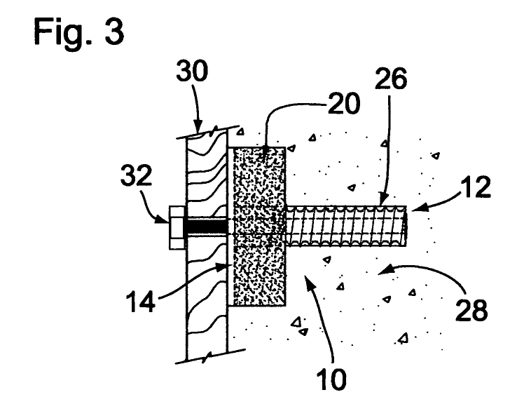

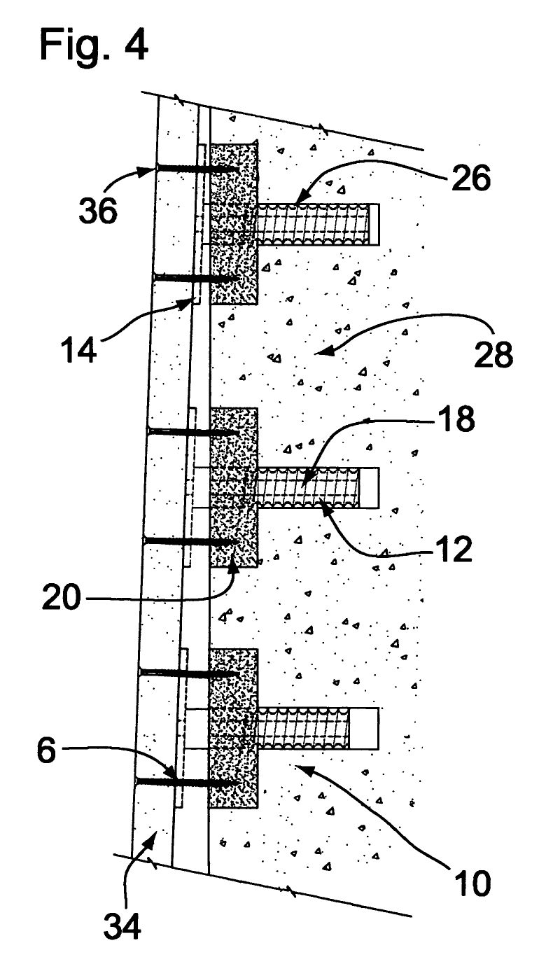

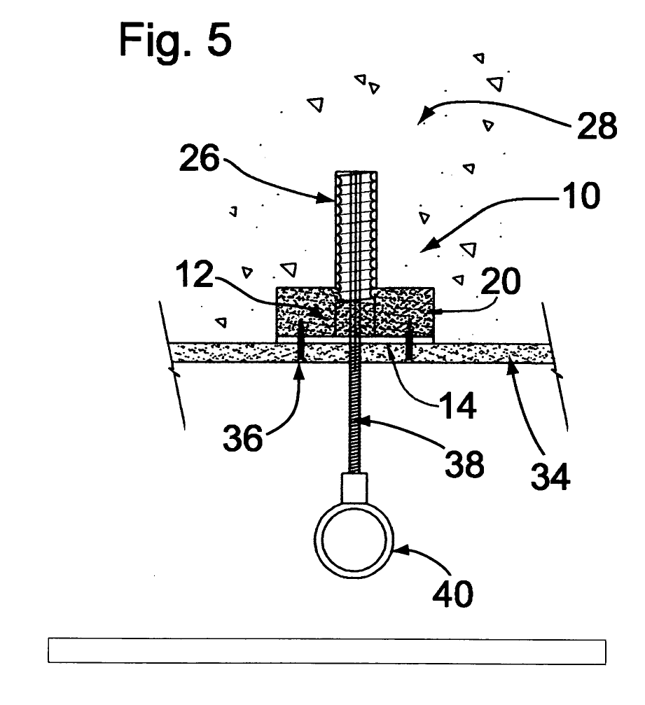

### DRAWING REFERENCE NUMERALS

10 Fastening device
12 Shaft
14 Flange
16 Adjustment hole
18 Shaft Bore
20 Flange Washer
22 Shaft Threads
24 Thread Crown
26 Releasable Thread Form
28 Concrete
30 Concrete Form
32 Mounting Bolt
34 Drywall Panel
36 Drywall Screw
38 Threaded Rod
40 Pipe Hangar Loop

I claim:

1. An ultra low friction readily adjustable fastener for concrete or other cold castable material comprising: a fully threaded or partially threaded shaft or stud separated from the concrete or cold castable material into which it is cast by an air gap separation produced by the covering of these threads with a partially compliant low friction dry film material that does not bond to the male portion or the said threaded shaft.

2. A shaft as in claim 1 which contains a fastening flange of any shape that is integral with said shaft that allows for the fastening, welding or attachment of other objects such as cladding materials to this shaft

3. A shaft as in claim 1 constructed of plastic.

4. A fastening flange as in claim 1 constructed of plastic.

5. A plastic as in claim 3 which is polypropylene.

6. A plastic as in claim 4 which is polypropylene.

7. A fastening flange as in claim 2 which contains a low density washer that permits piercing fasteners to pass through this flange and into a void in the hardened concrete or other cold castable material created by this washer

8. A low density washer as in claim 7 which is made of foamed plastic.

9. A foamed plastic as in claim 8 which is Styrofoam.
